(19) United States
(12) Patent Application Publication
(10) Pub. No.: US 2003/0070504 A1
(43) Pub. Date: Apr. 17, 2003

(54) Lever for a quick release device

(76) Inventor: Chin-Tsai Tsai, Changhua (TW)

Correspondence Address: Kolisch, Hartwell, Dickinson,, McCormack & Heuser, Suite 200, 520 S.W. Yamhill Street, Portland, OR, 97204-1378, US

(21) Appl. No.: 09/976,083

(22) Filed: Oct. 11, 2001

(51) Int. Cl. G05G 1/04

(52) U.S. Cl. 74/520

(57) ABSTRACT

A lever for a quick release device includes a back plate and two side plates respectively perpendicularly extending from two opposite sides of the back plate. Each side plate has an eccentric lobe extending from one of two ends of the side plate, and a hole is defined through each of the lobes and align with each other. A pivot pin is mounted in the hole. The side plates integrally extend from the back plate and are bent by a punching machine so that the manufacturing process is simplified and the lever is stronger.

### BACKGROUND OF THE INVENTION

1. Field of the Invention

The present invention relates to a lever, and more particularly to a lever for a quick release device.

2. Description of Related Art

A quick release device is widely used to clamp two elements for a long time, for example, to secure a stem in a head tube of a bicycle or any other pipe-like structure. With reference to FIG. 5, a conventional lever (30) for a quick release device in accordance with the prior art is made of aluminum alloy by die-casting. The lever (30) includes an eccentric first end having a pivot pin (40) pivotally mounted in the lever (30) and a second is flat end for a user to conveniently drive the quick release device. A shaft (41) has a first end securely inserted into the pivot pin (40) and a threaded second end. The quick release device usually includes two washers (not shown) and an adjusting member (not shown). The washers are mounted around the shaft (41) to abut the clamped object, and the adjusting member is screwed onto the threaded second end of the shaft (41) to adjust the distance between the two washers to accommodate the size of the clamped object.

However, the conventional aluminum lever (30) has the following disadvantages:

1. The aluminum alloy is an expensive metal. The manufacturing cost for a quality item is high.

2. The aluminum alloy is a soft alloy so the lever (30) is not strong enough to sustain a large force applied user and is easily worn.

The present invention has arisen to mitigate and/or obviate the disadvantages of the conventional lever for a quick release device.

### SUMMARY OF THE INVENTION

The main objective of the present invention is to provide a strong quick release device that can be manufactured at a low cost.

To achieve the objective, the lever for a quick release device in accordance with the present invention is integrally formed and includes a back plate and two side plates respectively perpendicularly extending from two opposite sides of the back plate. Each side plate has an eccentric lobe extending from one of two ends of the side plate, and each of the lobes has a hole defined through the lobe. The lobes align with each other to form a protrusion portion. The hole is provided to pivotally receive a pivot pin in the lobe.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a lever for a quick release device in accordance with the present invention;

FIG. 2 is a top plan view of the lever for a quick release device in FIG. 1 after cutting or stamping and before being bent into its final form;

FIG. 3 is a side plan view in partial section of the lever for a quick release in FIG. 1;

FIG. 4 is a cross sectional view of the lever for a quick release device along the line 4-4 in FIG. 3; and

FIG. 5 is a perspective view of a conventional lever for a quick release device in accordance with the prior art.

### DETAILED DESCRIPTION OF THE INVENTION

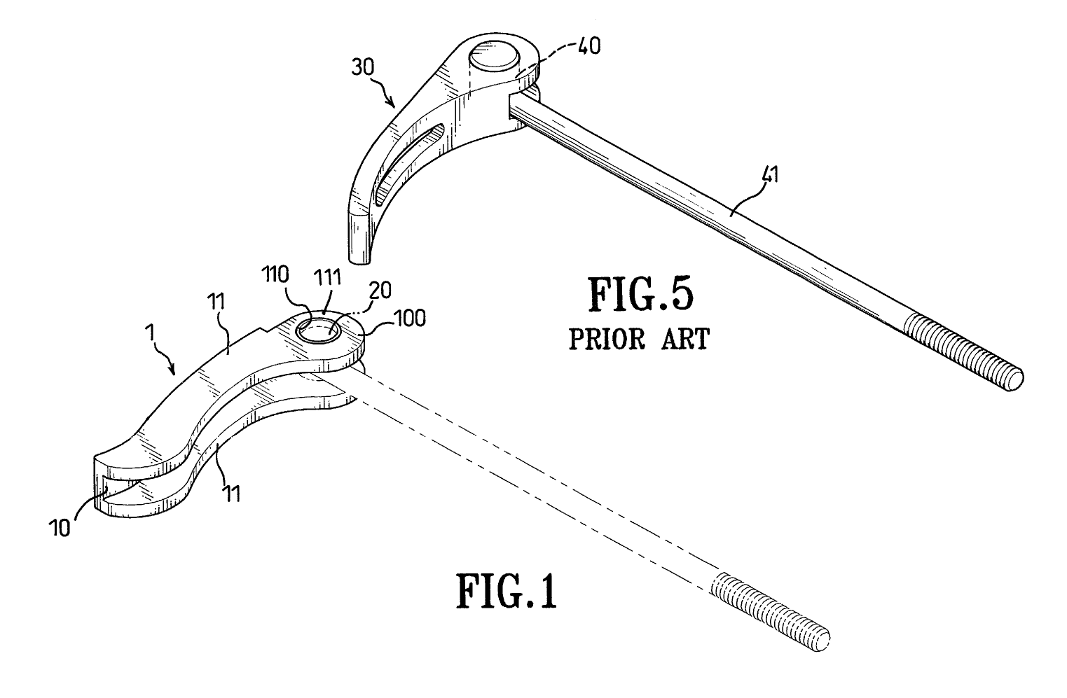

With reference to the drawings and initially to FIGS. 1, 3 and 4, a lever for a quick release device in accordance with the present invention is made from a sheet of metal by a punching machine. The lever for a quick release device comprises a back plate (10) and two side plates (11) respectively extending perpendicular from opposite sides of the back plate (10). Each side plate (11) has an eccentric lobe (100) extending from one of two ends of the side plate (11), and a hole (110) is defined through each lobe (100). The holes (110) align with each other. A pivot pin (20) is mounted in the holes (110). A shaft (not numbered) has a first end attached to the pivot pin (20). The quick release device usually includes two washers (not shown) and an adjusting member (not shown). The washers are mounted around the shaft to abut the clamped object, and the adjusting member is screwed onto a threaded second end of the shaft to adjust the distance between the two washers to accommodate the size of the clamped object.

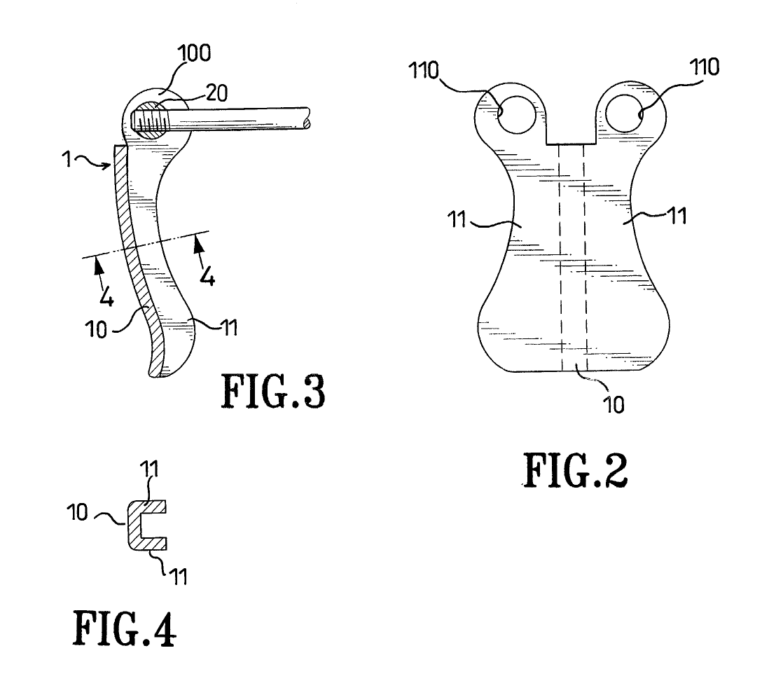

With reference to FIG. 2, to form the lever for a quick release in accordance with the present invention, the lever is formed from a sheet of metal by a punching machine. The longitudinal middle portion of the plate forms the back plate (10), and the sides on either side of the longitudinal middle portion of the plate are bent to form the two side plates (11). The punching machine also finishes the forming step of the lever. The cutting tool is changed to a forming mold so that the manufacturer only needs one punching machine.

As described, the lever for a quick release device has the following advantages.

1. The price of sheet metal is cheaper than aluminum the cheaper quick release device is cheaper.

2. The lever is stronger because the metal material is harder than the aluminum alloy.

3. The manufacturing process is simplified because the lever for a quick release device is manufactured by a punching machine.

Although the invention has been explained in relation to its preferred embodiment, it is to be understood that many other possible modifications and variations can be made without departing from the spirit and scope of the invention as hereinafter claimed.

What is claimed is:

1. A lever for a quick release device, the lever comprising:
a back plate; and
two side plates each perpendicularly extending from two opposite sides of the back plate, each side plate having an eccentric lobe extending from one of two ends of the side plate, and each of the lobes having a hole defined through the lobe and aligning with each other, and a pivot pin pivotally mounted in the hole;
wherein the side plates integrally extend from the back plate and are bent by a punching machine.
